(19) United States
(12) Patent Application Publication
(10) Pub. No.: US 2009/0265264 A1
(43) Pub. Date: Oct. 22, 2009

(54) Request for Market Stream

(75) Inventors: Florentin Bosse, Surrey (GB); Stephane Rio, Soisy sur Seine (FR); Vincent Boilay, Lingolsheim (FR)

Correspondence Address: BANNER & WITCOFF, LTD.,;ATTORNEYS FOR CLIENT NO. 006119, 10 SOUTH WACKER DRIVE, SUITE 3000, CHICAGO, IL, 60606, US

(73) Assignee: Chicago Mercantile Exchange, Inc., Chicago, IL (US)

(21) Appl. No.: 12/393,195

(22) Filed: Feb. 26, 2009

Related U.S. Application Data
(60) Provisional application No. 61/032,797, filed on Feb. 29, 2008.

(51) Int. Cl. G06Q 40/00

(52) U.S. Cl. 705/37

(57) ABSTRACT

Systems and methods are provided to implement request for stream functionality (RFS) into the trading environment. A request for stream may be submitted to determine liquidity of a particular financial instrument of interest to a customer. In response to a request for stream, quotes may be submitted by market markers within a predetermined amount of time. In an embodiment, a customer may determine which market makers receive the request for stream. The financial instruments may include Euro denominated interest rate swaps, U.S. denominated interest rate swaps, or OIS interest rate swaps.

This application claims the benefit of U.S. Provisional Application No. 61/032,797, filed Feb. 29, 2008 and entitled REQUEST FOR MARKET STREAM, the entire disclosure of which is hereby incorporated by reference.

### FIELD OF THE INVENTION

The invention relates to exchange trade matching systems and methods. More particularly, the invention relates to implementation of a request for stream functionality (RFS) into the trading environment.

### BACKGROUND

In existing Futures Exchanges, when a user wants to place an order in a continuous two sided market, their bids or offers are submitted and an attempt to match the users order is conducted. The bids and offers are placed in the book and are matched in real time on a price-time priority basis. A “Futures Contract” or “Futures” for short is a legally binding agreement to buy or sell a commodity or financial instrument at a later date. Futures contracts are standardized according to the quality, quantity and delivery time and location for each commodity. In the United States, futures are traded on an exchange regulated by the CFTC. A forward contract may have some of the same characteristics of a futures contract, however, a forward contract is a private, cash-market agreement between a buyer and seller for the future delivery of a commodity at an agreed price. In contrast to futures contracts, forward contracts tend not to be standardized or transferable.

Currently, the interest rate swap market is an over the counter (OTC) market. Over the counter (OTC) is a term used to refer to currency trading instruments which are not classified as a “futures” instrument as discussed above and not traded on a futures exchange. OTC contracts include forward contracts i.e. private agreements between buyers and sellers, i.e. bilateral contracts, for future delivery at an agreed price. While futures contracts are regulated by the Commodity Futures Trading Commission (“CFTC”), OTC contracts are not so regulated, making them more flexible and attractive.

An interest rate swap is a derivative contract in which an entity exchanges a stream of interest payments for another entity's stream of cash flows. Interest rate swaps are used to hedge fixed or floating interest rate assets and liabilities. An interest rate swap replicates an unfunded bond exposure. Trading of an OTC interest rate swap typically includes bilateral negotiations referred to as a “call around” market. In a call around market, brokers contact each other outside of an exchange trading facility to privately arrange trades. Bilateral negotiations allow for each entity to mange credit risk and select (or eliminate) specific counterparties. Such bilateral negotiations do not allow for features found in exchange traded products, such as trading strategies. Additionally, pricing of OTC interest rate structures is slow which decreases market liquidity and trading volume. Therefore, there is a need for a more robust and efficient electronic trade matching system and method.

### SUMMARY

Aspects of the present invention overcome problems and limitations of the prior art by providing a request for stream functionality.

In an aspect of the invention, a request for stream may be submitted to determine the liquidity of a particular financial instrument of interest to a customer. In response to a request for stream, quotes may be submitted by market markers within a predetermined amount of time. In an embodiment, a customer may determine which market makers receive the request for stream.

A market maker with a formal obligation to make markets is a dealer or person who has an obligation to buy when there is an excess of sell orders and to sell when there is an excess of buy orders. By maintaining an offering price sufficiently higher than their buying price, these market makers are compensated for the risk involved in allowing their inventory of securities to act as a buffer against temporary order imbalances. This term is sometimes loosely used to refer to a floor trader or “local” who speculates in the markets for his own account. An exchange may or may not compensate a person to take on the obligations of a market maker. In the equity exchanges, market makers are called specialists. Thus, a market maker may be under a formal obligation or merely a participant in the market place.

In a further aspect of the invention, a customer may modify a vanilla swap in order to customize the swap which may then be forwarded and negotiated with particular market makers. The negotiation may include changes to the notational value or duration of the interest rate swap.

In an embodiment of the invention, the financial products may include Euro denominated interest rate swaps, U.S. denominated interest rate swaps, or OIS interest rate swaps. The duration of the interest rate swaps may vary from zero to thirty years.

Details of the invention are set forth in the accompanying drawings and the description below. Other features and advantages of the invention will be apparent from the description, drawings, and claims.

### BRIEF DESCRIPTION OF THE DRAWINGS

Systems, methods and apparatuses for pre-execution credit controls are illustrated by way of example and not limited in the accompanying figures in which like reference numerals indicate similar elements and in which:

FIG. 1 shows a computer network system that may be used to implement various aspects of the invention.

FIG. 2 illustrates a method of requesting a market stream in accordance with an aspect of the invention.

FIG. 3 illustrates a request for stream blotter menu in accordance with an aspect of the invention.

FIG. 4 illustrates a request for stream order screen in accordance with an aspect of the invention.

FIG. 5 illustrates a market maker response to a requested RFS for an interest rate swap in accordance with an aspect of the invention.

FIG. 6 shows a market maker linking rates based on the spread from a supplied reference curve in accordance with an aspect of the invention.

FIG. 7 illustrates a RFS for a future cross in accordance with an aspect of the invention.

FIG. 8 illustrates the market maker reply screen for a futures cross in accordance with an aspect of the invention.

FIG. 9 illustrates a RFS for a spread issued by a user in accordance with an aspect of the invention.

FIG. 10 illustrates and a response from a market maker in accordance with an aspect of the invention.

FIG. 11 illustrates a RFS for a butterfly spread issued from a user in accordance with an aspect of the invention.

FIG. 12 illustrates a response from a market marker in accordance with an aspect of the invention.

FIG. 13 illustrates a RFS for a custom interest rate swap in accordance with an aspect of the invention.

FIG. 14 illustrates a customized product in accordance with an aspect of the invention.

FIG. 15 illustrates a RFS blotter in accordance with an aspect of the invention.

FIG. 16 illustrates a user accepting a market maker price in accordance with an aspect of the invention.

FIG. 17 illustrates a market maker interface screen in accordance with an aspect of the invention.

FIG. 18 illustrates to a user a completed transaction in accordance with an aspect of the invention.

FIG. 19 illustrates that a transaction has been competed in accordance with an aspect of the invention.

FIGS. 20 and 21 illustrate details of a completed transaction may be viewed in accordance with an aspect of the invention.

FIG. 22 illustrates an interface screen that may be used by users and/or market makers for preference adjustments to screen layouts and/or text formatting to suit needs in accordance with an aspect of the invention.

### DETAILED DESCRIPTION

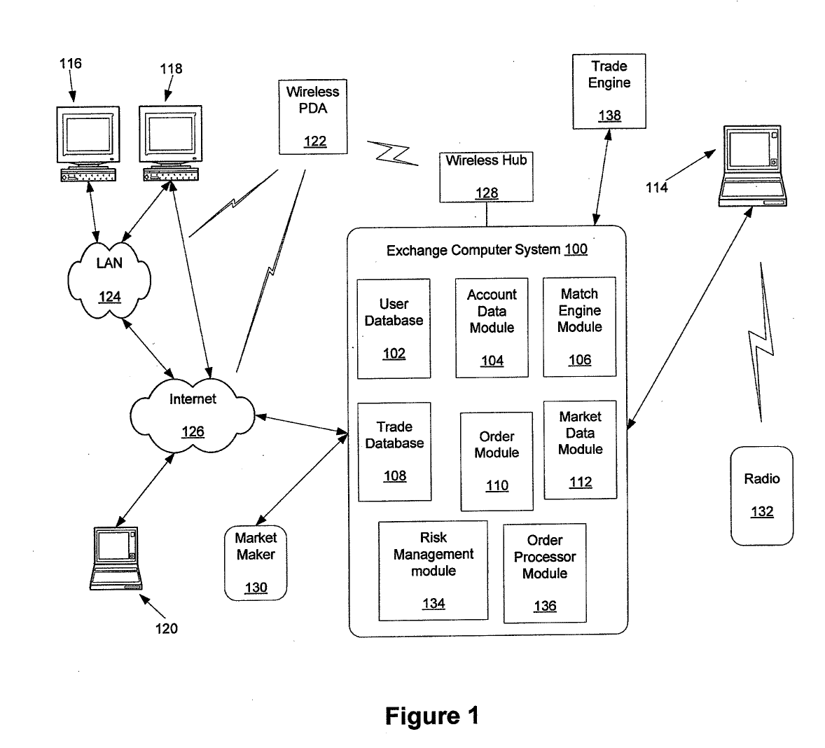

Aspects of the present invention are preferably implemented with or used in conjunction with computer devices and computer networks. An exemplary trading network environment for implementing trading systems and methods is shown in FIG. 1. An exchange computer system 100 receives orders and transmits market data related to orders and trades to users or customers. Exchange computer system 100 may be implemented with one or more mainframe, desktop or other computers. A user database 102 includes information identifying traders and other users of exchange computer system 100. Data may include user names and passwords.

An account data module 104 may process account information that may be used during trades. A match engine module or trade matching engine 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processor module 136 may be included to decompose delta based and bulk order types for processing by order book module 110 and trade matching engine 106.

The trading network environment shown in FIG. 1 includes computer devices 114, 116, 118, 120, and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory, and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

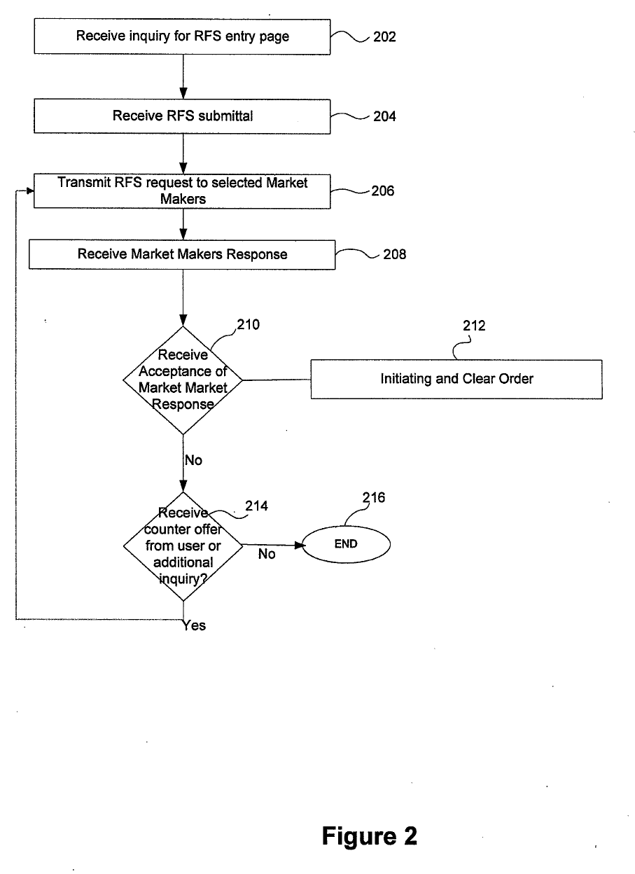

Referring to FIG. 2, a method of requesting a stream in a trade matching engine 106 is illustrated in accordance with an aspect of the invention. In an aspect of the invention, a user or customer may have a choice regarding which market makers may have a chance to respond to a request for stream. This choice may be due in part to predefined permission relationships or by sending the request for stream to a subset of predefined trading relationships.

In FIG. 2, an inquiry in step 202 regarding a request for stream may be received. The inquiry may include a request for RFS input screen. A user may complete the RFS input screen which may be received by the trade matching system in step 204. The RFS may ask the marketplace to post liquidity for a particular instrument of interest to the user.

In step 206, the RFS may be transmitted to selected market makers. In response to the RFS, orders or quotes may be submitted as illustrated in step 208. The response may only be allowed within a predetermined amount of time after which a response is no longer accepted.

In step 210, a user may determine if the received information which may include information regarding price and quantity is acceptable. If the information in the RFS is acceptable the trade matching engine may begin the process of initiating and/or clearing the completed order in step 212. In an aspect of the invention, after acceptance, a potential negotiation element may commence between the user and the chosen market maker. If the information in the RFS is not acceptable, then the user may make a counter offer or additional offer and/or end the inquiry in step 214.

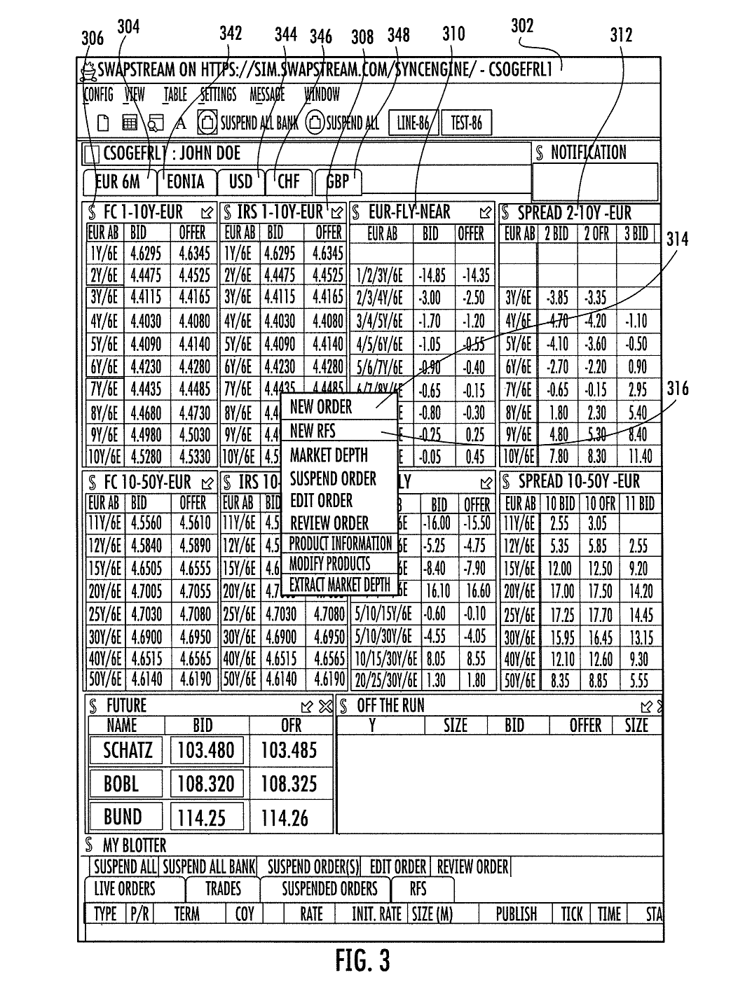

In FIG. 3, a request for stream blotter menu 302 is illustrated in accordance with an aspect of the invention. The request for stream blotter menu 302 may be displayed to users interested in trading interest rate swaps or other financial products. The request for stream blotter menu 302 may display current prices for various interest rate products based on information received from market makers. In FIG. 3, tab 304 illustrates various interest rate swaps denominated in Euros. For example, tab 304 illustrates both bid and offer prices for various future crosses 306, interest rate swaps 308, butterfly spreads 310, and various other spreads 312 based on the Euro. In other aspects of the invention, additional tabs may correspond to different interest rate swaps that may be traded such as interest rate swaps based on Euro Overnight Index Average (EONIA) tab 342, U.S. Dollar denominated swaps tab 344, Swiss Franc denominated swaps 346, and Great Britain Pound denominated swaps 348.

In FIG. 3, a user may select a product of interest by right clicking on the displayed product. A drop down box 314 may be activated based on the user's selected product. One exemplary option contained in the drop down box 314 may be to select a request for stream (RFS) 316 for the selected product.

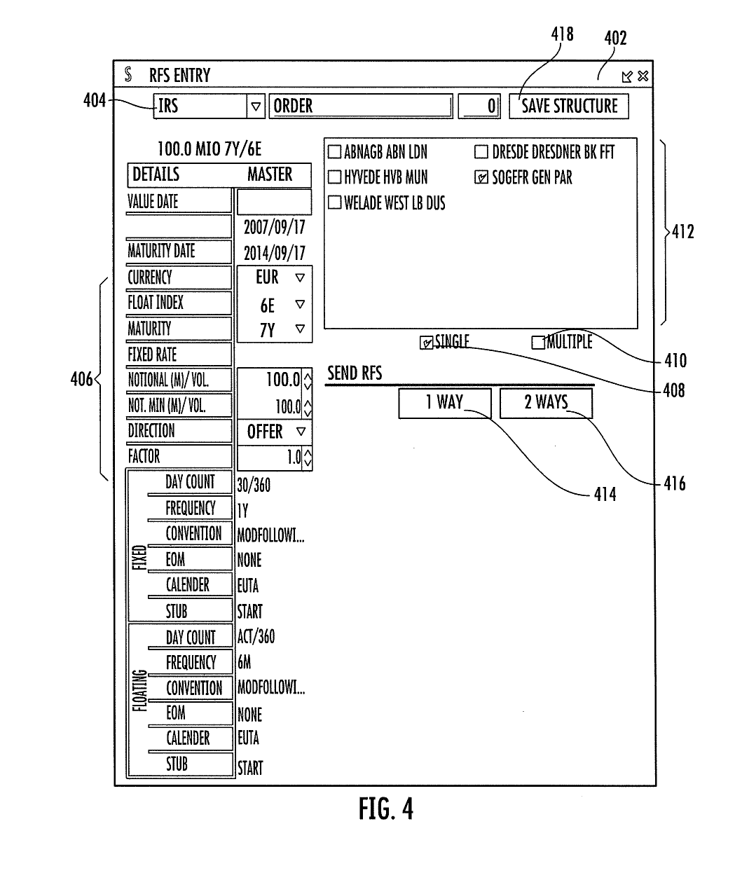

FIG. 4 illustrates a request for stream (RFS) order screen 402 in accordance with an aspect of the invention. In RFS order screen 402, a user may be interested in pricing a vanilla interest rate swap. In an embodiment, the user may be offering the interest rate swap at a particular price to various market makers or requesting bids from market makers for the interest rate swap. The user may select an RFS type using drop down box 404. In FIG. 4, an interest rate swap has been selected as the RFS type 404. The user may enter specifics regarding the interest rate swap of interest in RFS order screen 402. For example, FIG. 4 illustrates that the user is interested in a 100 million Euro denominated seven year swap as shown with the user entered information 406. In another embodiment, the specifics of the interest rate swap or other product may be pre-filled on the RFS order screen 402 based on user selection from the request for stream blotter menu 302.

Next, in FIG. 4 a user may also determine if the interest rate swap is of a single 408 or multiple 410 hit type. The hit type may indicate that if a user receives a favorable price from a market maker that the order may be duplicated for additional orders having the same favorable pricing structure. In the exemplary embodiment of FIG. 4, a single hit 408 has been selected by the user.

In an aspect of the invention, a user may select a number of market makers to receive the RFS using selection box 412. In an embodiment, the user may select up to three market makers to receive the RFS. Those skilled in the art will realize that in different embodiments the number of market makers that may be selected to receive the RFS may be higher or lower than three. In an embodiment, a number of market makers may already be selected as a default for the user based on a selected interest rate swap. In another embodiment, a user may be selected with various market makers that have sponsored the particular user as a default for consideration for responding to a RFS.

In a further aspect of the invention, a user may select the direction to send the RFS. For example, a user may select to send the RFS in either a one-way 414 or two-way 416 direction. Sending the RFS request using a two-way 416 direction allows the market maker to come back to the user with an alternative transaction and allows for further negotiation based on the submitted RFS.

In yet another aspect of the invention, the structure of a RFS may be saved 418 for sending during a different session or time period or for use again in a different trading session. Furthermore, the RFS may be saved 418 as part of overall trading strategy. The overall trading strategy may be displayed on a blotter giving a user a visual representation of their overall trading strategy.

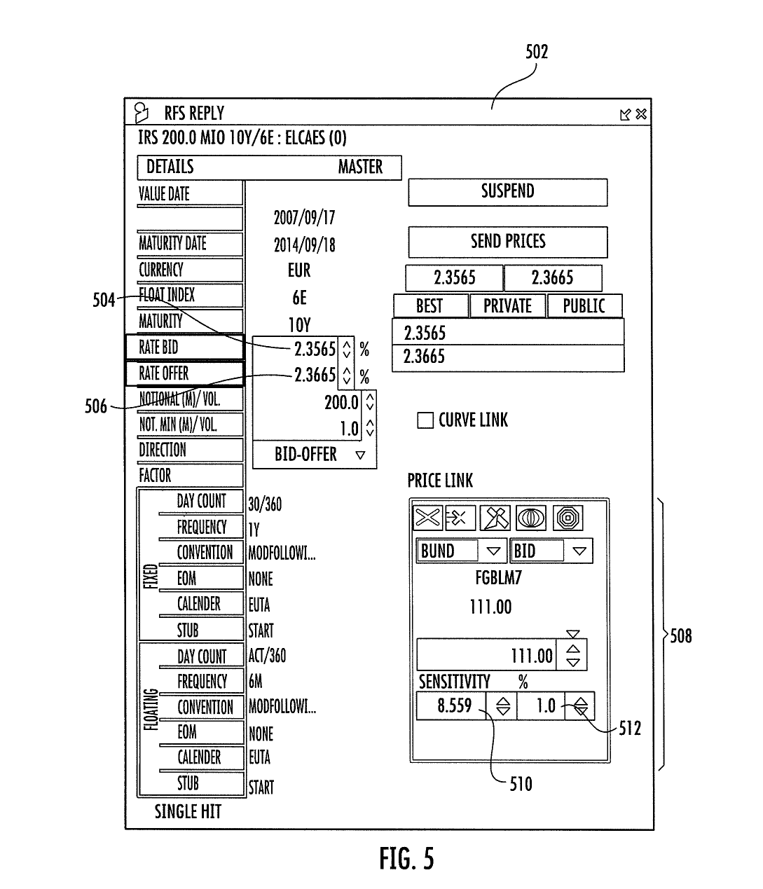

FIG. 5 illustrates a market maker response to a requested RFS for an interest rate swap in accordance with an aspect of the invention. In FIG. 5, a market maker reply screen 502 is illustrated in which a market maker may reply to a received RFS. In FIG. 5, the market marker is giving a rate for a 200 million 10 year interest rate swap with a bid rate of 2.3565 percent 504 and an offer rate of 2.3665 percent 506. The market maker via the market maker reply screen 502 is replying to a two-way request with a future linked answer 508. As shown in FIG. 5, the market maker is linking the bid and offer rates to an underlying future such as the June Bund future FGBLM7 in order to keep the prices in line with the Bund. In an embodiment, the market maker may adjust the sensitivity 510 and the percentage 512 to determine how closely the rates track to the underlying future.

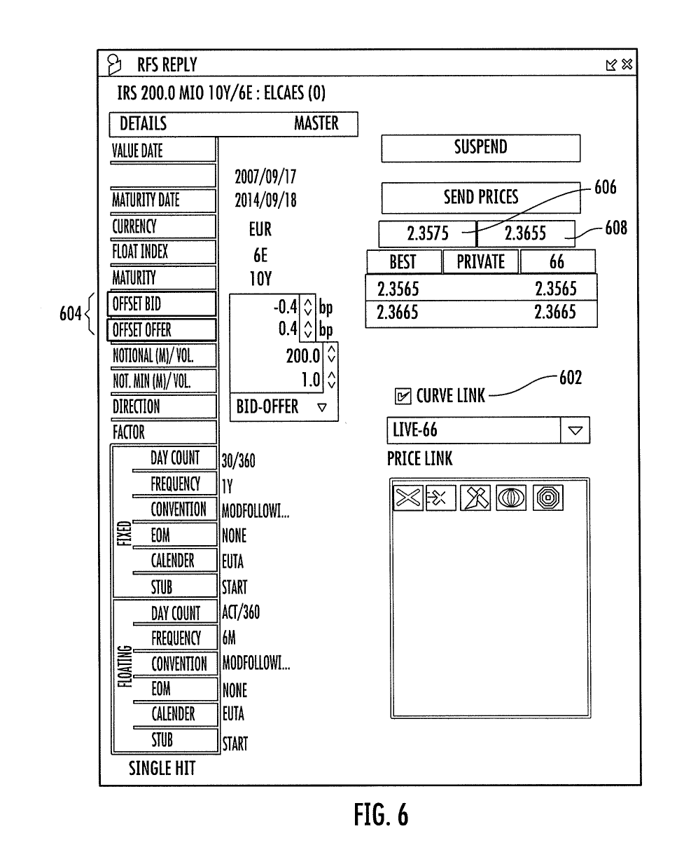

In another aspect of the invention, FIG. 6 shows a market maker linking rates based on the spread from a supplied reference curve 602. For example, the spread may be +/−0.4 basis points 604. In an embodiment, the midpoint of a bid of 2.3565% and offer of 2.3665% is 2.3615%. With a spread of +/−0.4 basis points 604, the bid sent to a user may be calculated as 2.3615−0.4=2.3575 (606). Additionally, the offer sent to the user may be calculated as 2.3615+0.4=2.3655 (608).

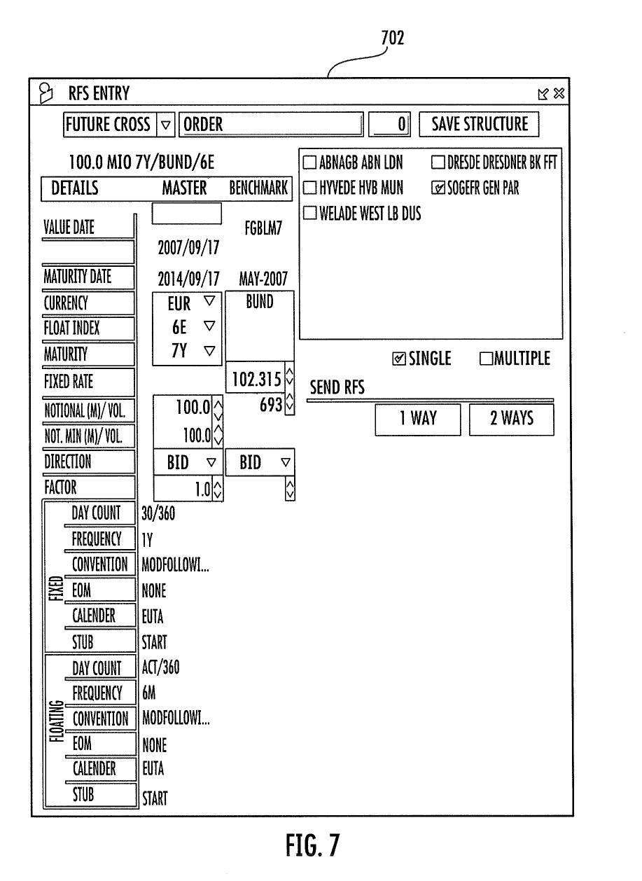

FIG. 7 illustrates a RFS for a future cross in accordance with an aspect of the invention. In FIG. 7, a request for stream order screen 702 for a 7 year future cross against the Bund is illustrated. In an aspect of the invention, the displayed market makers which can be selected by the user may be different than the market makers displayed in the above vanilla interest rate swap example. However, similar to the vanilla interest rate swap example, a user may select a one-way or two-way RFS and single and/or multiple hit type.

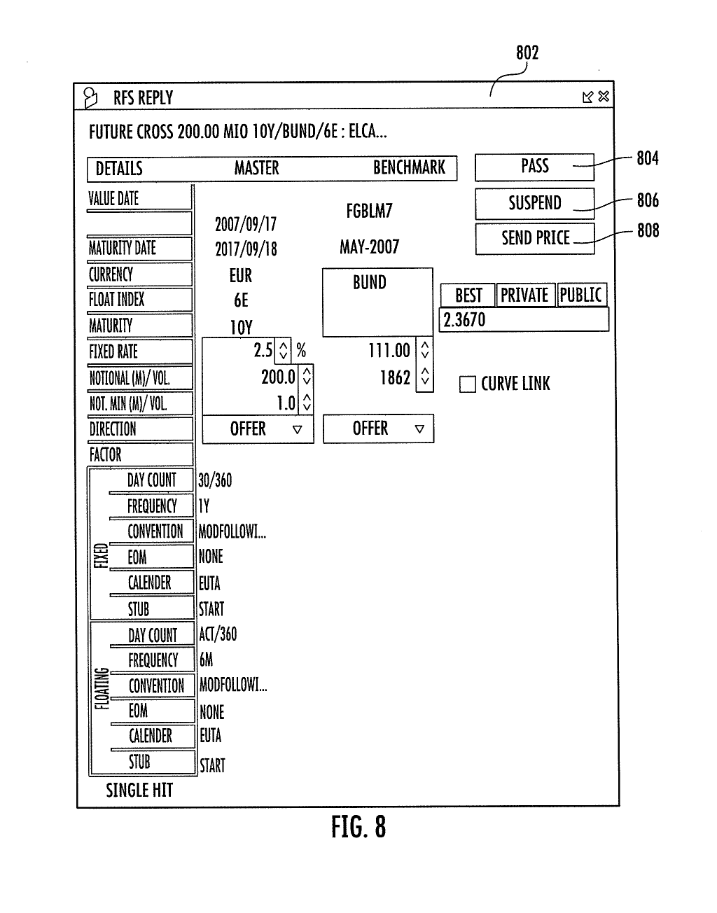

FIG. 8 illustrates the market maker reply screen 802 for a futures cross in accordance with an aspect of the invention. In FIG. 8, the market maker may pass 804 on the received RFS. In other words for this particular RFS, the market maker does not wish to present a quote to the user. In another embodiment, the market maker may suspend or freeze a particular price 806 to keep it from changing. When the market maker has completed the quote, the price or quote may be sent 808 from the market maker to the user.

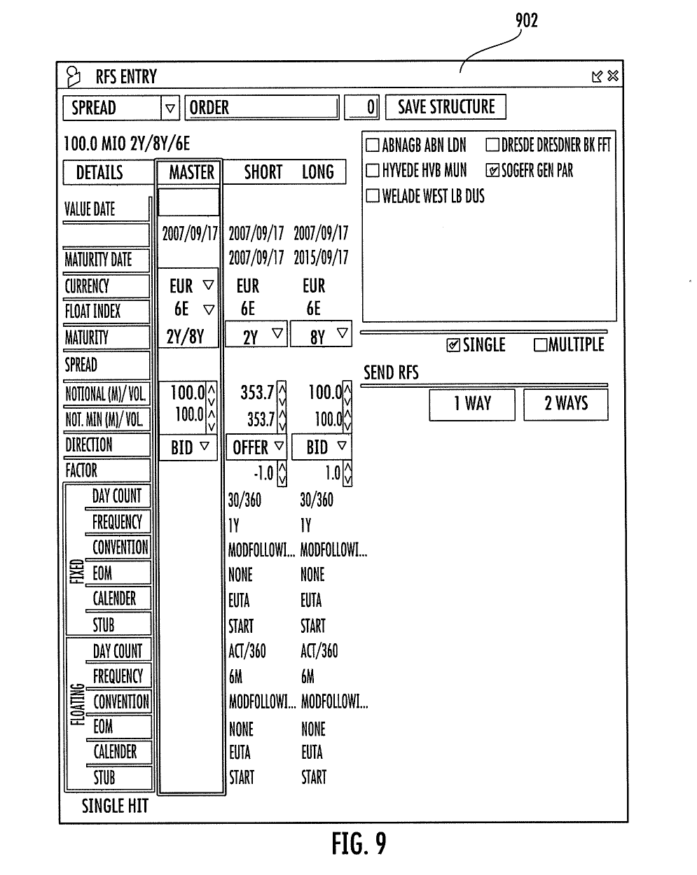

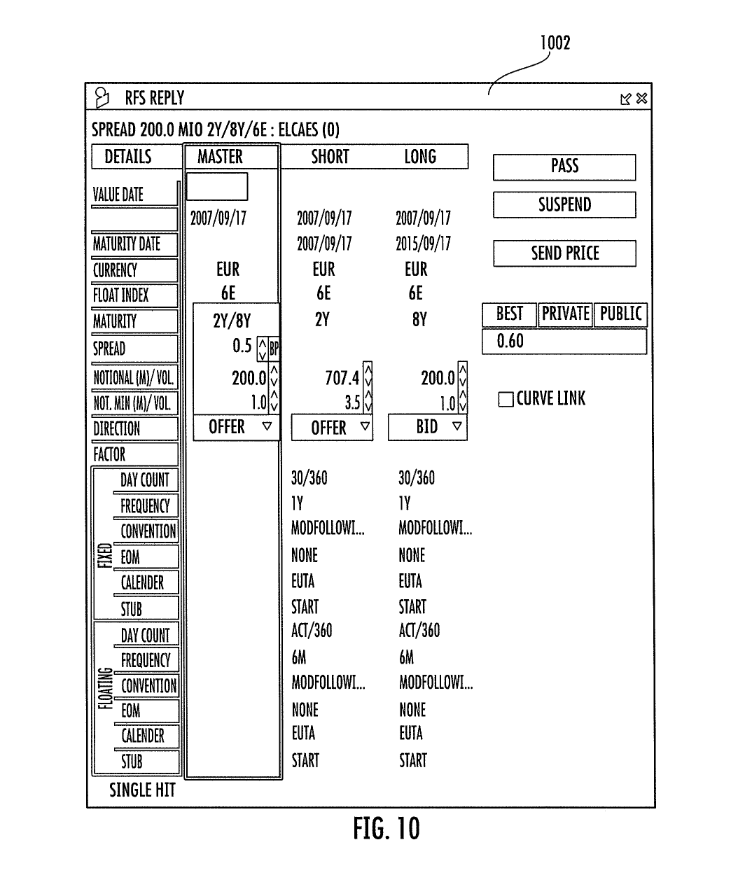

FIGS. 9 and 10 illustrate a RFS for a spread issued by a user (FIG. 9; 902) and a response from a market maker (FIG. 10; 1002) in accordance with an aspect of the invention.

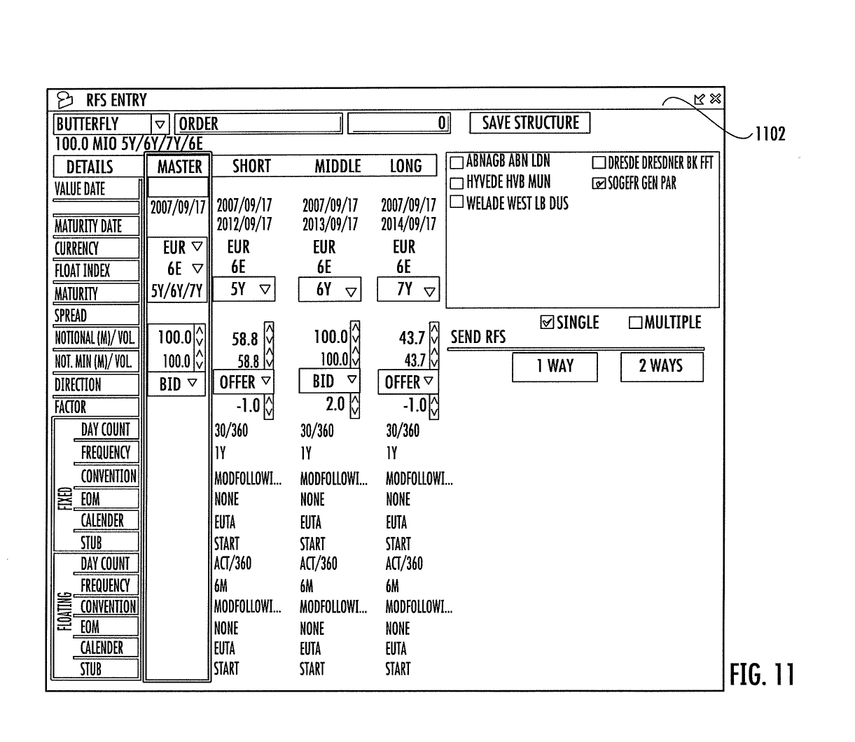

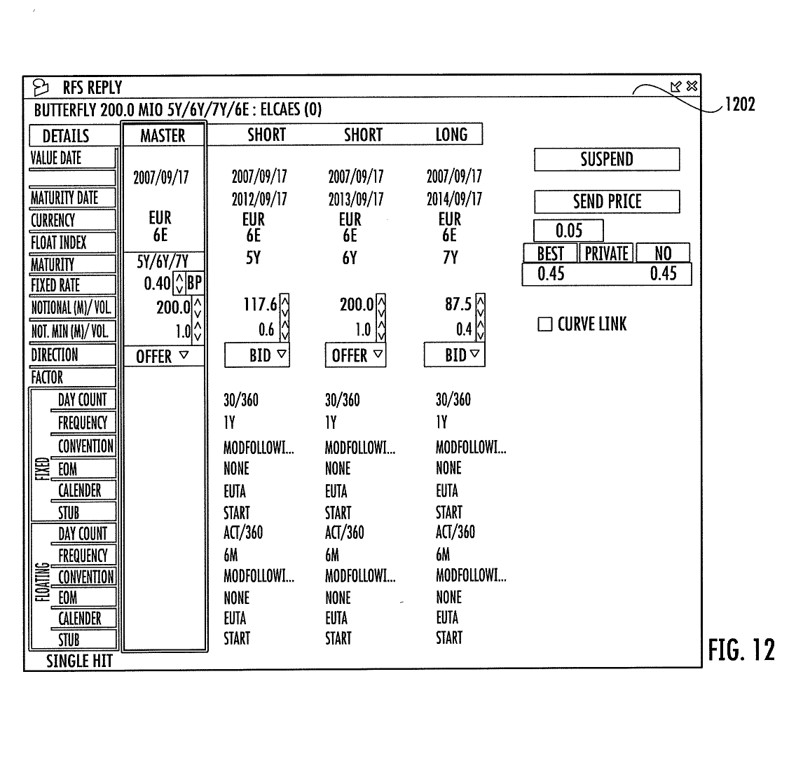

FIGS. 11 and 12 illustrate a RFS for a butterfly spread issued from a user (FIG. 11; 1102) and a response from a market marker (FIG. 12; 1202) in accordance with an aspect of the invention.

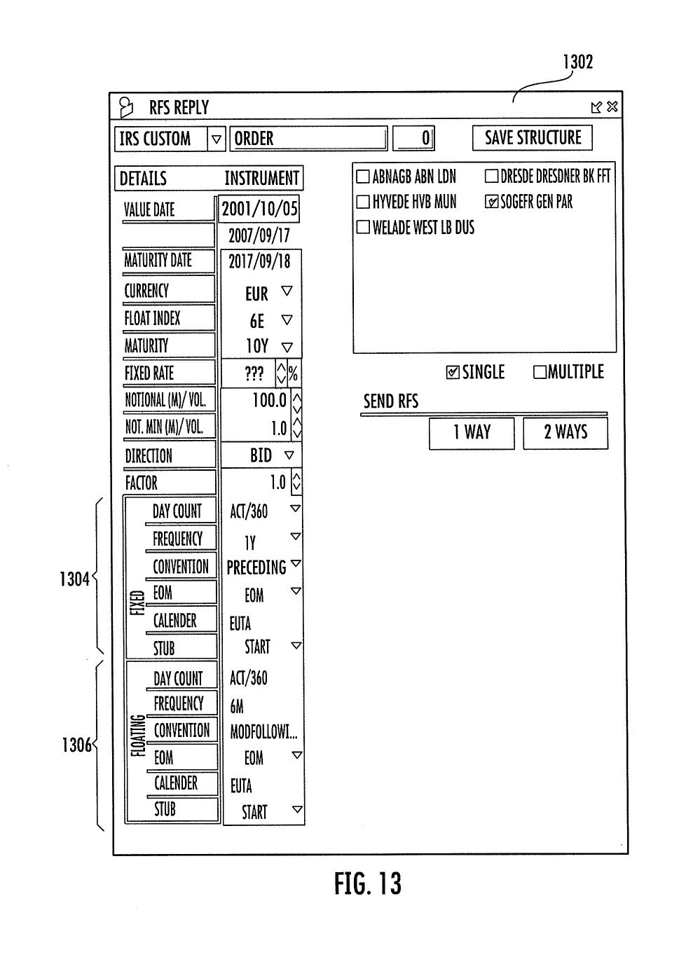

FIG. 13 illustrates a RFS for a custom interest rate swap in accordance with an aspect of the invention. As shown in FIG. 13, a user in a request for stream order screen 1302 may customize both the fixed 1304 and floating 1306 legs of an interest rate swap. The customization of the swap may enable a user to implement a particular trading strategy that may be more difficult or not possible to implement without customization of the interest rate swap.

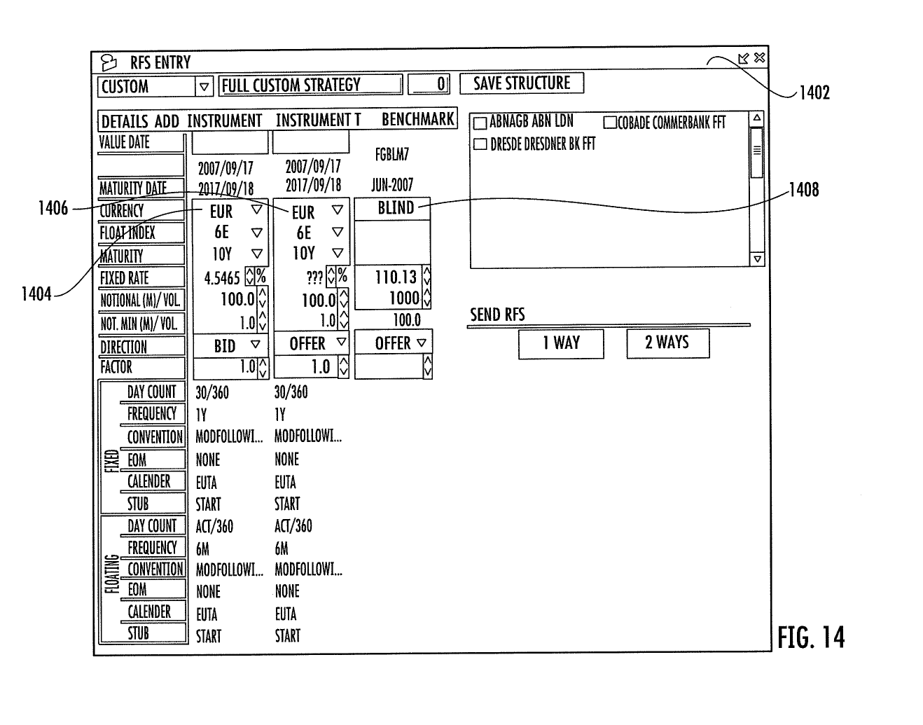

FIG. 14 illustrates a fully customized product in accordance with an aspect of the invention. In FIG. 14, a user in a request for stream order screen 1402 may create a customized swaps or as many underlying futures as necessary to implement their trading strategy. For example, the user in the request for stream order screen 1402 is configuring two different interest rates swaps (1404 and 1406) and is configuring a benchmark on a Bund 1408.

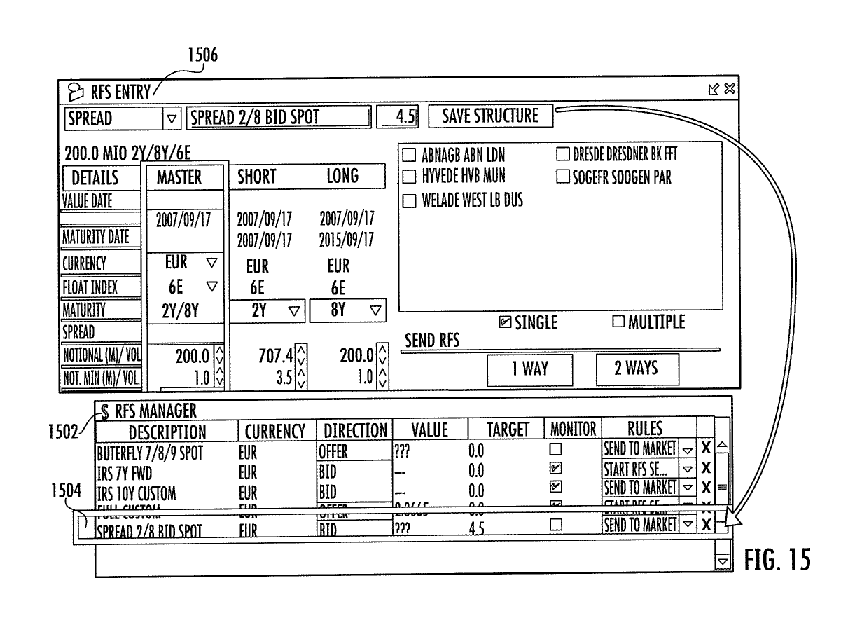

FIG. 15 illustrates a RFS blotter 1502 in accordance with an aspect of the invention. The RFS blotter 1502 shown in FIG. 15 illustrates a particular strategy that a user may be currently implementing. In another aspect of the invention, the RFS blotter 1502 may illustrate a future strategy that may or may not be implemented by a user.

In an aspect of the invention, a user may determine the status or implement a particular strategy directly from RFS blotter 1502. In an embodiment, a user may select a particular swap and the underlying details and status of the swap may be displayed to the user. For example, a user may select a spread 1504, the underlying details of which may be displayed on user interface screen 1506.

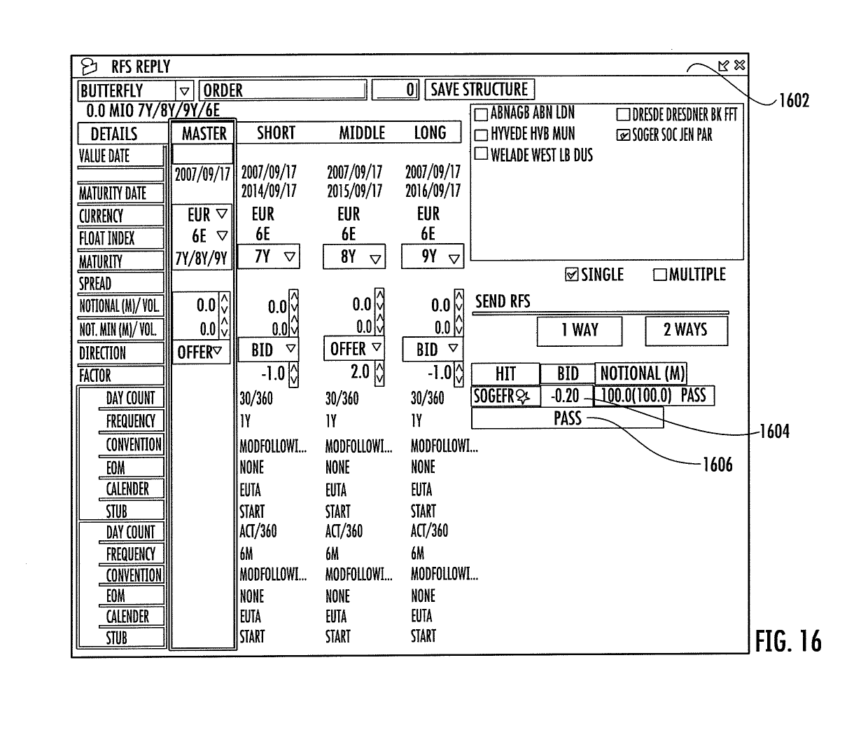

FIG. 16 illustrates a user accepting a market maker price in accordance with an aspect of the invention. In FIG. 16, the prices received by the user shown on screen 1602 may be acceptable to the user. A user may click the Bid of −0.20 (1604) to lock in or freeze the price. If the price is acceptable to the user, the user may click the Bid of −0.20 (1604) a second time to accept the market maker's bid. In an alternative embodiment, if the user does not like the price, the user may select the pass selection box 1606 to reject the Bid of −0.20 (1604).

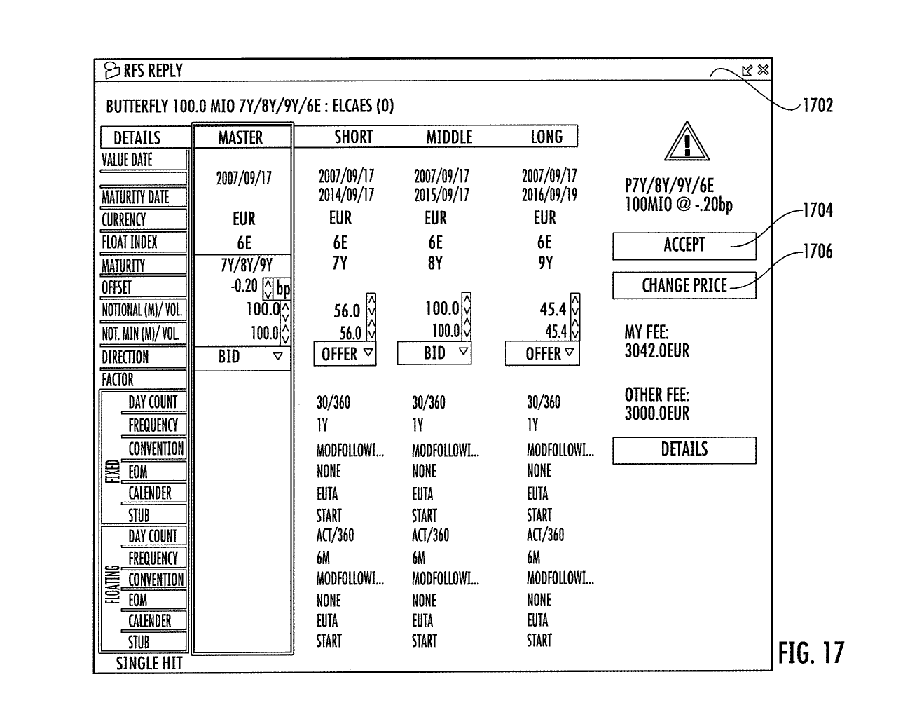

FIG. 17 illustrates a market maker interface screen 1702 in accordance with an aspect of the invention. In FIG. 17, a market maker receives acknowledgment that the user has accepted the bid. In an embodiment, the market maker may accept the transaction by selecting the “accept” box 1704. In another embodiment, the market maker may decide to change the price of the RFS which may be done by activation of the change price box 1706. In an aspect of the invention, until both parties have acknowledged acceptance of the transaction, the transaction is not completed.

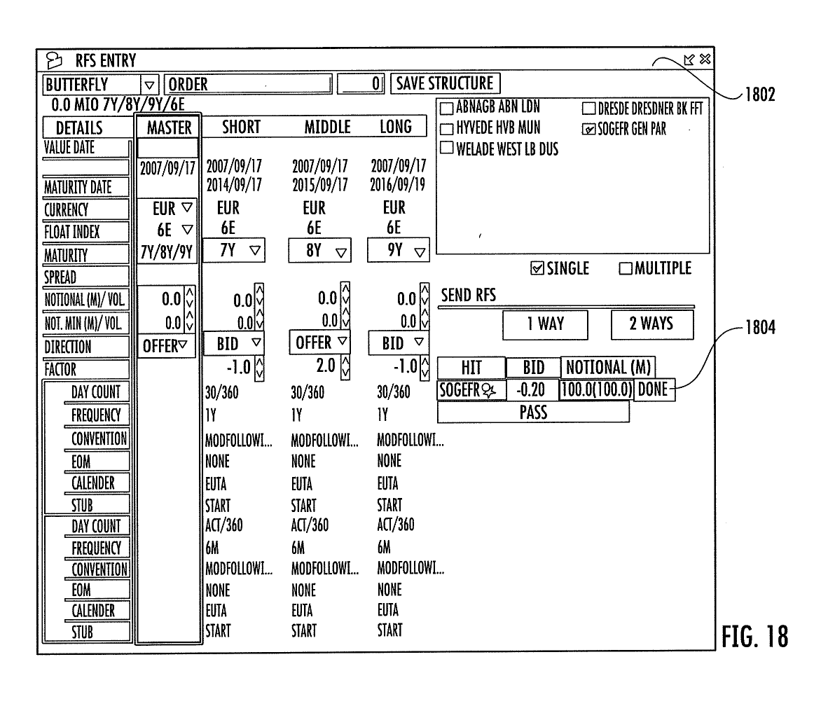

FIG. 18 illustrates to a user a completed transaction in accordance with an aspect of the invention. In FIG. 18, a screen 1802 illustrates acknowledgement that the market maker has accepted the transaction as indicated by the done box 1804.

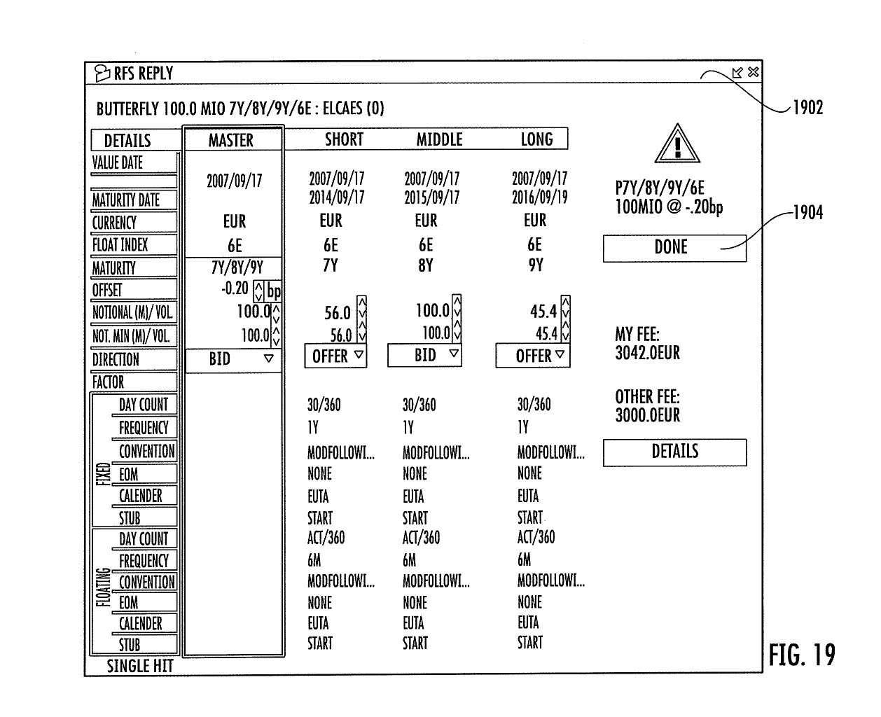

FIG. 19 illustrates that a transaction has been competed in accordance with an aspect of the invention. In FIG. 19, a market maker screen 1902 illustrates acknowledgement that the transaction has been completed as indicated by the done box 1904.

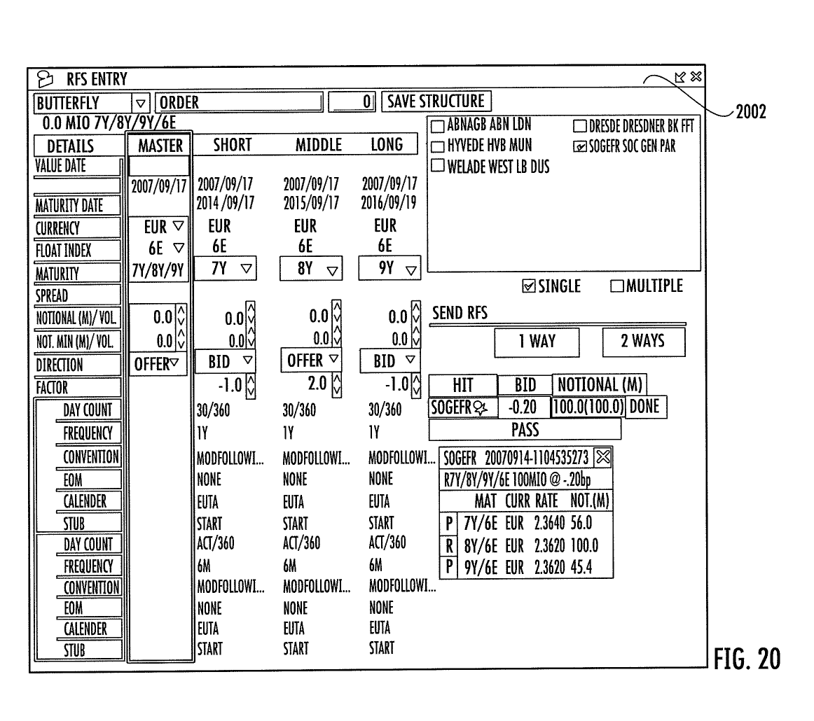

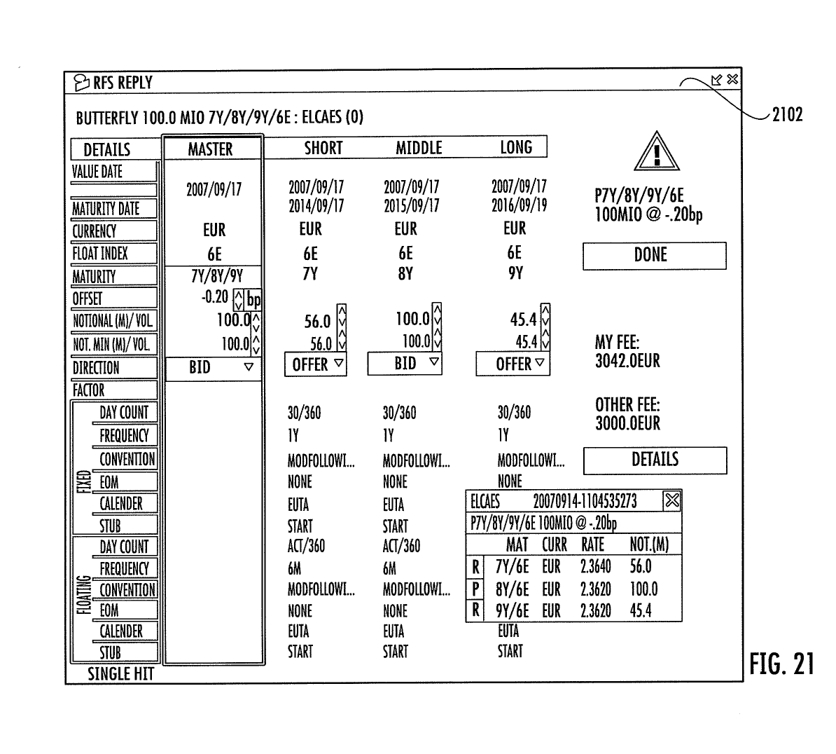

FIGS. 20 and 21 illustrate in screen 2002 and 2102 that the details of a completed transaction may be viewed in accordance with an aspect of the invention.

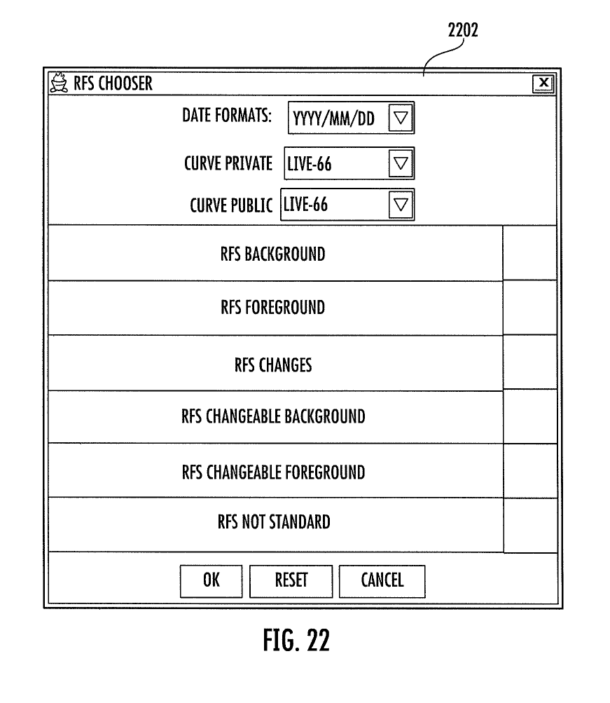

FIG. 22 illustrates in screen 2202 that a user and/or market maker may make preference adjustments to screen layouts and/or text formatting to suit individual needs in accordance with an aspect of the invention.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended exemplary aspects of the invention. All are considered within the sphere, spirit, and scope of the invention.

We claim:

1. A method of trading financial instruments between a user and a market maker, the method comprising:
(a) receiving information regarding a request for stream inquiry, the request for stream inquiry including an order price and indicia of the financial instruments;
(b) receiving a selection of market makers to receive the request for stream inquiry;
(c) transmitting a request for stream request to the selected market makers; and
(d) receiving at least one streaming offer from the selected market makers based on the transmitted request for stream request.

2. The method of claim 1, further comprising the step of:
(e) transmitting the at least one streaming offer to the user; and
(f) completing a transaction based on the at least one streaming offer.

3. The method of claim 1, wherein (b) further includes receiving a one-way transaction selection.

4. The method of claim 1, wherein (b) further includes receiving a two-way transaction selection.

5. The method of claim 1, wherein the at least one streaming offer includes a linked rate based an underlying futures contract.

6. The method of claim 5, wherein the linked rate of the streaming offer is further adjusted with sensitivity and percentage adjustments.

7. The method of claim 2, further comprising the step of:
(g) displaying a blotter showing an overall trading strategy.

8. The method of claim 1, wherein the financial instruments include interest rate swaps.

9. The method of claim 1, wherein the financial instruments include future crosses.

10. The method of claim 1, wherein the financial instruments include butterfly spreads.

11. A system for trading financial instruments between a user and a market maker, the system comprising:
(a) an order module configured to receive a request for stream inquiry regarding a financial instrument and transmit a request for stream request to at least one market maker based on the request for stream inquiry; and
(b) a match engine module configured to receive a response from the at least one market maker to the request for stream request and transmit the received response to the user.

12. The system of claim 11, wherein the match engine module accepts the received response from the at least one market maker if the received response is transmitted by the at least one market maker within a predetermined period of time.

13. The system of claim 11, wherein the financial instruments include interest rate swaps.

14. The system of claim 11, wherein the financial instruments include future crosses.

15. The system of claim 11, wherein the financial instruments include butterfly spreads.

16. A computer-readable medium including computer-executable instructions for causing a computer device to perform the steps comprising:
(a) receiving information regarding a request for stream inquiry, the request for stream inquiry including an order price and indicia of the financial instruments;
(b) receiving a selection of market makers to receive the request for stream inquiry;
(c) transmitting a request for stream request to the selected market makers;
(d) receiving at least one streaming offer from the selected market makers based on the transmitted request for stream request;
(e) transmitting the at least one streaming offer to the user; and
(f) completing a transaction based on the at least one streaming offer.

17. The computer-readable of claim 16, wherein (b) further includes receiving a one-way transaction selection.

18. The computer-readable of claim 16, wherein (b) further includes receiving a two-way transaction selection.

19. The computer-readable of claim 16, wherein the at least one streaming offer includes a linked rate based an underlying futures contract.

20. The computer-readable of claim 16, wherein the linked rate of the streaming offer is further adjusted with sensitivity and percentage adjustments.
